(19) United States
(12) Patent Application Publication
(10) Pub. No.: US 2017/0238474 A1
(43) Pub. Date: Aug. 24, 2017

(54) COMPOSITE TRELLIS WITH PERMANENT BASE

(71) Applicant: ALF Operating Partners, Ltd., Fort Worth, TX (US)

(72) Inventor: M. John Fakhari, Forth Worth, TX (US)

(73) Assignee: ALF Operating Partners, Ltd., Fort Worth, TX (US)

(21) Appl. No.: 15/436,028

(22) Filed: Feb. 17, 2017

Related U.S. Application Data
(60) Provisional application No. 62/297,224, filed on Feb. 19, 2016.

(51) Int. Cl. A01G 9/12

(52) U.S. Cl. CPC A01G 9/12

(57) ABSTRACT

A fan trellis manufactured from a composite fiber material includes a lower crossbar configured as a base for the trellis that attaches around, and is permanently affixed to, the lower ends of a series of vertical rods, securing them in a desired position. The rods extend upwardly through apertures in middle and upper crossbars that bow the vertical rods into a fan shape.

### CROSS-REFERENCE TO RELATED APPLICATION

This application claims the benefit of U.S. Provisional Patent Application No. 62/297,224, filed Feb. 19, 2016, the disclosure of which is hereby incorporated herein in its entirety by reference.

### BACKGROUND OF THE INVENTION

Field of the Invention

The present invention relates generally to trellises. More specifically, the invention relates to a fan trellis formed from a fiber reinforced composite material and having a permanent base.

Background & Description of the Related Art

Trellises are commonly used in gardening and landscaping to provide support to growing plants and to offer decorative interest to a garden. Fan trellises, in particular, are popular as the spreading fan shape is aesthetically pleasing and also provides a large support area that is well adapted for use with various garden and decorative plants. A fan trellis is typically placed with its narrow end down, resting on or in the ground or other surface, with the spreading fan portion extending upwardly and outwardly. The trellis is often placed against a wall which provides vertical support, but it can also be freestanding, with the bottom end secured in the ground or supported within a stand.

Conventional trellises, however, suffer from a number of drawbacks. For example, most trellises are used in conjunction with plants and gardening environments, thus they are subjected to constantly varying moisture and temperature conditions and are often exposed to direct sunlight throughout the day. Because most trellises are made of wood, the harsh environment accelerates the decay of that wood, resulting in deterioration and breakage of the trellis over time.

Furthermore, the assembly and manufacture of conventional trellises results in a product that is inherently not very durable. For instance, in some common trellis designs the vertical rods are attached to horizontal cross boards by simply tying or gluing the rod to the cross bar. That attachment is particularly susceptible to deterioration, and weakens as the trellis is exposed to the elements, resulting in loosened or unattached vertical rods. In other common trellis designs, the vertical rods are secured only by being push-fit through holes in a series of horizontal cross bars. While the push-fit connections may initially be sufficient to retain the vertical rods, over time and after exposure to the elements the rods can loosen or move within the push-fit holes, again resulting in loose or unattached vertical rods. The movement or loosening of the vertical rods at the base or lower crossbar is particularly problematic as the base portion is often positioned directly against the soil, increasing its exposure to environmental elements and because the movement of the vertical rods in the base affects the stability of the entire trellis.

Thus, it can be seen that there is a need in the art for a trellis that does not easily deteriorate upon exposure to the elements, and that is assembled in a secure, permanent matter so that the trellis maintains its positioning and structural integrity over time.

### SUMMARY OF THE INVENTION

The present invention is directed to a fan trellis manufactured from a composite fiber material. In an exemplary embodiment, the trellis includes a lower, or base, crossbar configured as a base for the trellis that attaches around, and is permanently affixed to, the lower ends of a series of vertical rods, permanently securing them in a desired position and in close proximity at the lower portion of the trellis.

The lower crossbar comprises two elongated rectangular halves, the first half including protruding tabs and the second half including recessed receptacles configured to receive the tabs. Each half further includes a series of semicircular recessed areas shaped and sized to conform to a portion of the outer diameter of a corresponding vertical rod. With the vertical rods in place between the two halves of the lower crossbar, aligned with the corresponding semicircular recessed areas in each half, the tabs on the first half are snapped into the receptacles on the second half to secure the two halves together with the rods trapped therebetween. In alternative embodiments, the two halves are further glued or welded together with the rods trapped therebetween, and/or the two halves are glued or welded to the rods.

A middle crossbar, longer than the lower crossbar, is positioned near the mid-section of the trellis, placed over the vertical rods from their upper, unsecured ends. A series of apertures extending through the middle crossbar receive and position the corresponding vertical rods in a desired spaced-apart relationship. An upper crossbar, longer than the middle crossbar, is positioned at the upper portion of the trellis, similarly placed over the vertical rods via a series of apertures so that the upper portion of the rods are positioned in a desired spaced-apart relationship. The progressively wider spacing of the apertures encompassing the vertical rods between the lower crossbar, the middle crossbar, and the upper crossbar gradually directs the vertical rods outwardly to form the fan shaped trellis.

In one embodiment the vertical rods are of differing lengths and diameters, with the center rod being larger in diameter and with the rods at the outer edges being shorter in length to impart a tapered appearance to the assembled trellis. In alternative embodiments, the rods may be of identical length and diameter, or may be any desired combination of lengths and diameters.

### BRIEF DESCRIPTION OF THE DRAWINGS

FIG. 1 is a perspective view of a trellis having a permanent base in accordance with an exemplary embodiment of the present invention.

FIG. 2 is a front view of the trellis of FIG. 1.

FIG. 3 is an exploded perspective view of the base of the trellis of FIG. 1.

FIG. 4 is an exploded, alternate perspective view of the base of FIG. 3.

FIG. 5 is a plan view of the base of FIG. 3.

FIG. 6a is a close-up view of a portion of the first half of the base of FIG. 5 depicting a barbed tab extending threrefrom.

FIG. 6b is a close-up view of a portion of the second half of the base of FIG. 5 depicting a “T”-shaped receptacle formed therein.

FIG. 6c is a close-up view of the barbed tab of FIG. 6a fully inserted into the “T”-shaped receptacle of FIG. 6b.

### DETAILED DESCRIPTION OF EXEMPLARY EMBODIMENTS

Various embodiments of the present invention are disclosed herein, it is to be understood that the disclosed embodiments are merely exemplary of the invention, which may be embodied in various forms. Thus, any specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

Certain terminology used in the following description is for convenience in reference only and is not limiting. For example, the words “vertically”, “horizontally”, “vertical”, “horizontal” and “upwardly”, “downwardly”, “upper”, “lower” all refer to the installed position of the item to which the reference is made. The words “inwardly” and “outwardly” refer to directions toward and away from, respectively, the geometric center of the embodiment being designated and parts thereof. The terminology used herein may include the words specifically mentioned, derivatives thereof and words of a similar import. It is further understood that terminology such as the aforementioned directional phrases may be used to describe exemplary embodiments of the trellis as shown in the figures herein, specifically with the wider fan portion of the trellis positioned vertically above the narrower base portion. This is for convenience only as it is understood that the exemplary embodiments of the trellis described may also be used horizontally, at an angle, or in an inverted position.

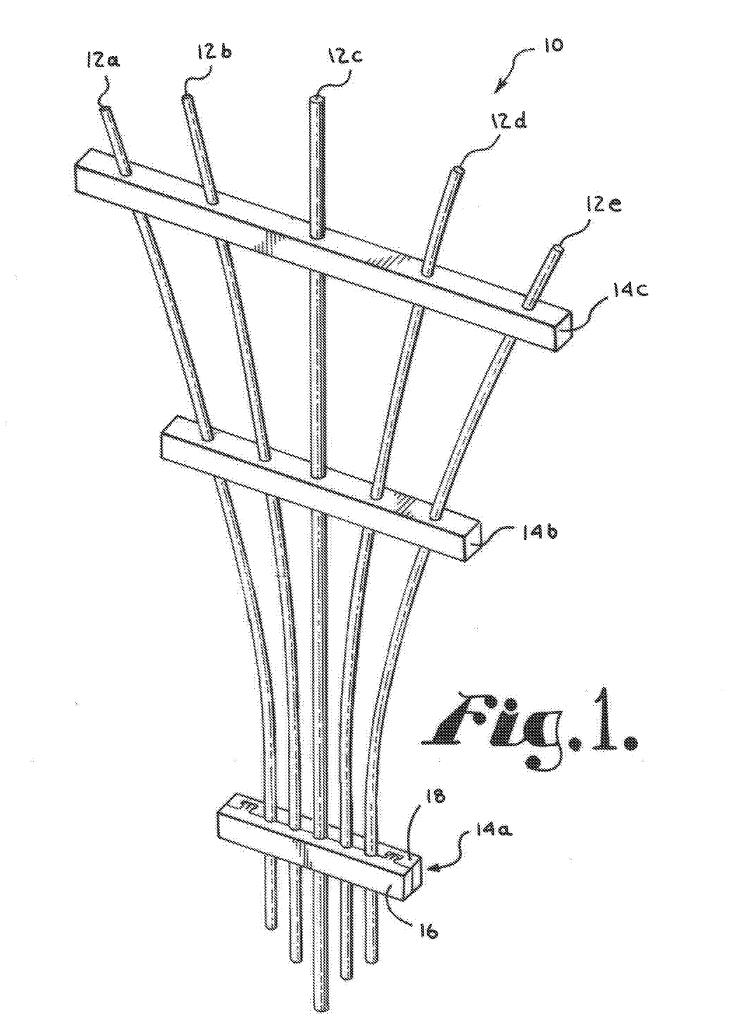

Looking first to FIGS. 1 and 2, a trellis with permanent base in accordance with an exemplary embodiment of the present invention is referenced generally by the numeral 10. The trellis 10 includes five generally vertical rods 12a, 12b, 12c, 12d, 12e positioned and retained in a fan shape by three horizontal cross bars—lower crossbar 14a, middle crossbar 14b, and upper crossbar 14c.

As seen in FIG. 1, the lower crossbar 14a is comprised of first and second halves, 16, 18 positioned on opposite sides of the vertical rods. As shown in FIG. 2, a series of apertures extending through each of the middle and upper crossbars allows the corresponding vertical rod to pass through each cross bar, with the spacing between the apertures positioning the rods in a desired spaced-apart position within that rod. The longer length of, and wider spacing between the apertures in, the upper cross bar as compared to the shorter length and narrower spacing between the apertures in the middle cross bar situate the vertical rods into a slightly bowed orientation, resulting in the overall fan-shaped appearance of the trellis.

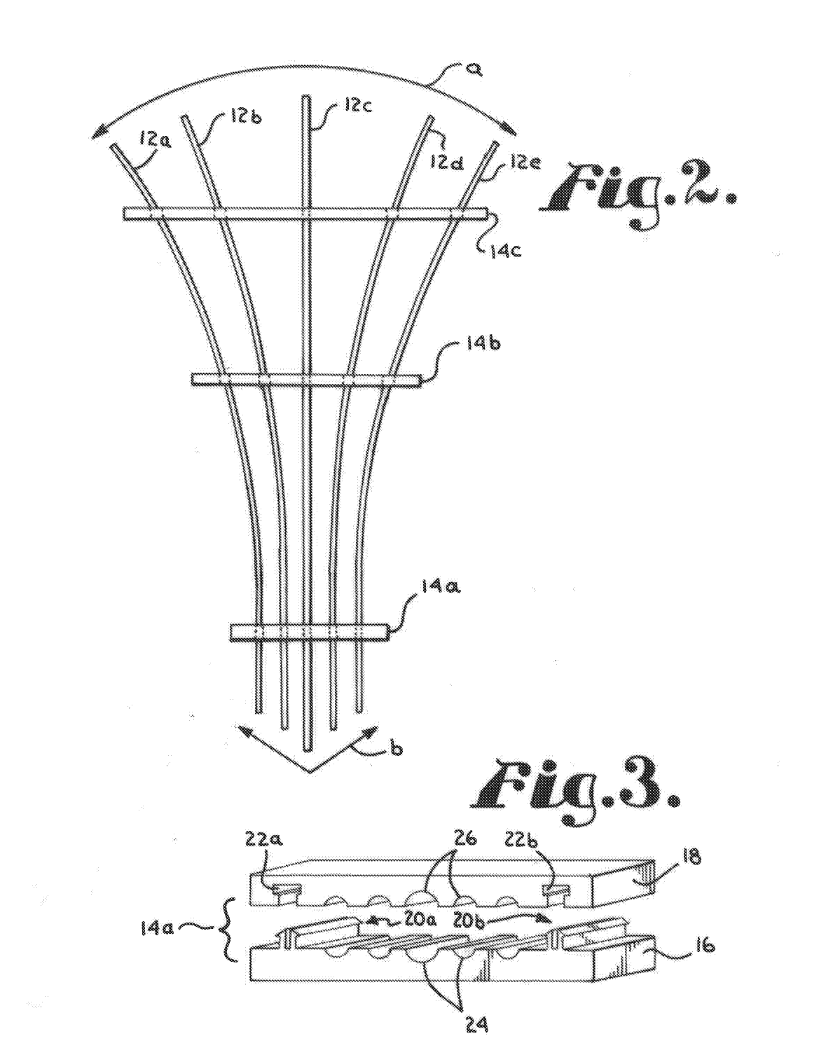

Looking also to FIGS. 3-5 and as will be described in more detail below, the lower crossbar 14a comprises first and second elongated rectangular halves 16, 18. The first half 16 includes two protruding, generally pentagonal-shaped or barbed tabs 20a, 20b on an inner surface configured to mate with corresponding “T”-shaped slots 22a, 22b formed in an inner surface of the second half 18. A series of semicircular recessed receptacles 24, 26 in the first and second halves, respectively, cooperate to define apertures surrounding the corresponding vertical rods when the first and second halves are joined together around those rods.

In a manner similar to that already described with respect to the upper crossbar and the middle crossbar, the apertures formed in the lower crossbar 14a are more closely spaced than those in the middle crossbar, so that the outer vertical rods bow slightly in their transition from the middle crossbar to the lower crossbar. This bowing further contributes to the overall fan-shaped appearance of the trellis as previously described.

In the exemplary embodiment of the trellis depicted in FIGS. 1 and 2 the center vertical rod 12c is larger in diameter and longer than the other vertical rods, with the outermost two rods 12a, 12e being shorter than the others. The combination of the larger and longer center rod 12c and the decreasing length of rods from the center of the trellis to the outer edges accentuates the fan-shaped appearance of the trellis, with the virtual upper edge a of the trellis (formed by the upper ends of the vertical rods) forming an arc shape and the virtual lower edge b of the trellis (formed by the lower ends of the vertical rods) forming a point.

In the embodiment shown, the vertical rods are of varying lengths and shapes, with a middle rod having a larger diameter and length than the others, and with the outermost rods being shorter than the others to provide a tapered appearance to the assembled trellis. In alternative embodiments, the vertical rods may be identically sized and shaped, or may be a combination of various sizes and shapes. For example, the vertical rods may be square, hexagonal, or any other desired shape. In such cases, the apertures in the crossbars, and the recessed areas in the lower crossbar, would be configured to conform to the shape and diameter or outer dimension of the corresponding rod being received.

It should be further understood that a trellis in accordance with the present invention may include fewer or more vertical rods than the five depicted in the exemplary embodiment, and may include fewer or more horizontal crossbars than the three depicted in the exemplary embodiment. These and other variations are contemplated by and are within the scope of the present invention.

The vertical rods are preferably constructed of a composite material having properties that resist deterioration when exposed to moisture, temperature extremes, and sunlight. Most preferably, the vertical rods are made of a glass fiber reinforced thermosetting resin or polymer (FRP), sometimes referred to as fiberglass. Most preferably, the vertical rods are formed using a pultrusion process in which reinforcing fibers or matting are pulled through a vat of resin and then through a heated die where the resin is cured or set. The pultrusion process permits the rods to be fabricated to any desired length by cutting as it is being pultruded.

The upper and lower crossbars are preferably similarly constructed of a composite material such as a fiber reinforced thermosetting resin using a pultrusion process to form the rectangular bars which are cut to a desired length as they are being pultruded. The circular apertures in the upper and lower crossbars are drilled, cut, or otherwise formed in the pultruded crossbar and are sized to accommodate the vertical rods to be used and are spaced to achieve the desired fan appearance of the trellis. It is also foreseen that the upper and lower crossbars can be formed using other materials or means, such as by injection molding using a thermoplastic material.

Turning to FIGS. 3-5, the lower crossbar 14a is comprised of two elongated rectangular halves, 16, 18. The first half 16 includes protruding, generally pentagonal-shaped, resilient barbed tabs 20a, 20b configured to mate with corresponding “T”-shaped slots 22a, 22b in the second half 18. As shown in FIG. 5, each pentagonal tab is formed of two arrow shaped projections 25, 27 extending upwardly from the inner surface of the upper half and positioned in close proximity, defining a narrow gap 28 between the two.

Looking still to FIG. 5, each arrow shaped projection 25 comprises a rectangular body portion 30 extending upwardly and terminating in a pointed end portion 32, with the inner side of the pointed end portion flush with the inner side of the rectangular body portion. The outer edge of the pointed end portion extends beyond the outer side of the rectangular body portion, forming a lip 34 or barb at the juncture between the rectangular body portion and the pointed end portion. Arrow shaped projection 27 is a mirror image of arrow shaped projection 25, oriented in an opposite facing direction. The oppositely-oriented arrow shaped projections 25, 27 in combination form the generally barbed tab 20a. As is apparent in the figures, barbed tab 20b is essentially identical to barbed tab 20a, but positioned towards the opposite end of the first half 16. As can be seen in FIGS. 3, 5, and 6a, each barbed tab 20a, 20b is elongated, extending across the width of first half 16.

The narrow gap 28 between the two arrow-shaped projections 25, 27 of the barbed tab permit the projections to deflect inwardly toward each other (into gap 28) so that the tab may be inserted into the mating receptacle on the second half, as will now be described.

As best seen in FIGS. 3, 5, and 6b, “T”-shaped slot 22a in second half 18 comprises a rectangular vertical channel 36 extending upwardly or outwardly from the inner surface of the second half 18. The vertical channel 36 merges with a rectangular horizontal channel 38 extending parallel to the inner surface of the second half. The horizontal and vertical channels 36, 38 in combination form a “T” shaped slot opening in the second half, with the juncture between the two channels 36, 38 defining two ledges 40, 42 at opposing sides of the slot. As can be seen in the figures, slot 22b is essentially identical to slot 22a, but positioned toward the opposite end of the second half. As can also be seen, each slot 22a, 22b is elongated, extending across the width of the second half.

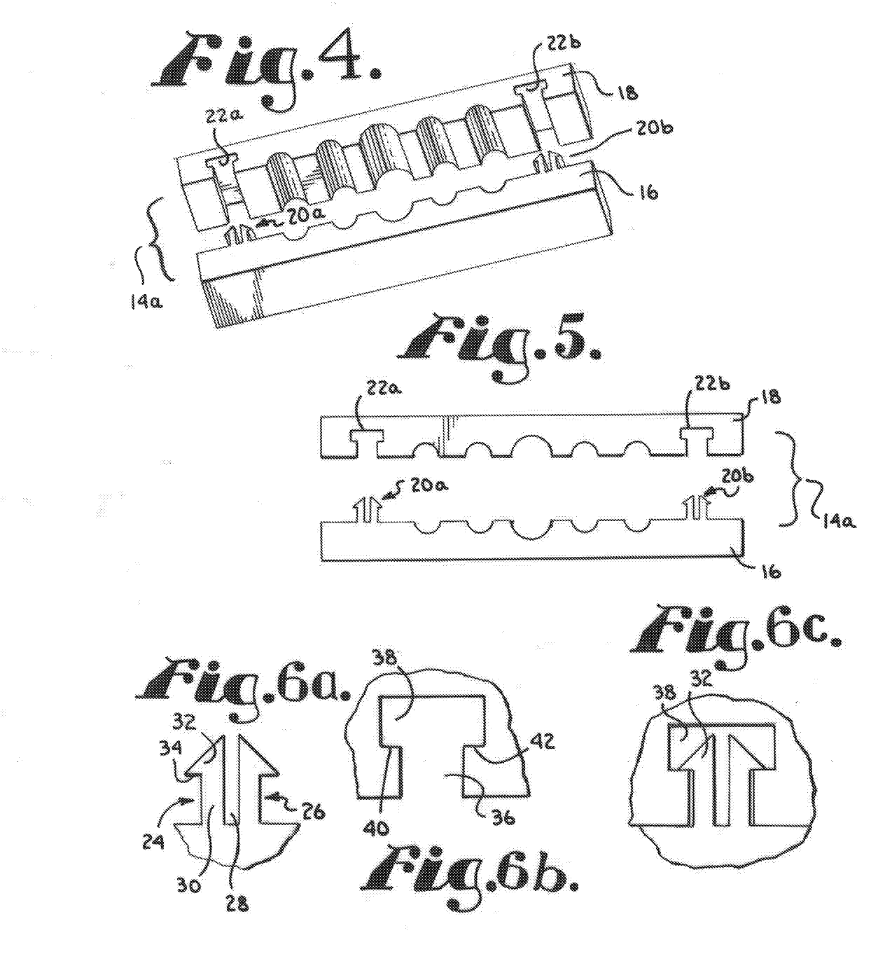

Looking to FIGS. 5, 6a, 6b, and 6c, it can be seen that the barbed tabs 20a, 20b on the first half 16 are aligned with the “T”-shaped slots 22a, 22b in the second half 18. As can also be seen in those figures, the dimensions of the barbed tabs 20a, 20b correspond substantially to the dimensions of the “T”-shaped slots 22a, 22b, such that the width of the slot is essentially the same as the width of the barbed tab, and the depth of the slot is essentially the same as the height of the barbed tab.

Thus, as shown in the figures, the first and second halves 16, 18 can be secured together by inserting the barbed tabs 20a, 20b on the first half 16 into the corresponding “T”-shaped slots 22a, 22b in the second half 18. As the tabs are pressed into the slots, as previously described, the arrow shaped projections 25, 27 of each tab deflect inwardly toward each other, into gap 28, so that the tab fits into the vertical channel portion 36 of the “T”-shaped slot until the tab is fully inserted, projecting into the horizontal channel portion 38 of the “T”-shaped slot. Once the tab is fully inserted into the slot, the resiliency of the material causes the arrow shaped projections 25, 27 to spring outwardly, back to their original vertical positions, so that the lip 34 of each projection rests against the corresponding ledge 40 of each slot, thus securing the two halves 16, 18 together.

With the two halves 16, 18 of horizontal crossbar attached as just described, the vertical rods 12a, 12b, 12c, 12d, 12e are secured or trapped therebetween, forming a fixed base for the trellis. Most preferably, the inner surface of each half is coated with a fiberglass glue or adhesive, such as a cyanoacrylate adhesive, prior to assembly so that the vertically-extending rods are adhered to each half and the halves are adhered to each other. Alternatively, the two halves may be secured by using other adhesives or methods of securement known in the art, such as plastic welding, likewise the vertical rods may alternatively be secured to one or both halves using adhesives or other known methods of securement. Thus adhered, the glued halves and rods form an integral, fixed base that is resistant to deterioration by moisture, weather, sunlight, and other environmental conditions.

It should be understood that while certain forms and embodiments have been illustrated and described herein, the present invention is not to be limited to the specific forms or arrangement of parts described and shown, and that the various features described may be combined in ways other than those specifically described without departing from the scope of the present invention. The terms “substantially”, “generally”, “approximately”, or any other qualifying term as used herein may be applied to modify any quantitative representation which could permissibly vary without resulting in a change to the basic function to which it is related. For example, the dimensions of the pentagonal tabs are described as conforming substantially to the dimensions of the tab, but may permissibly vary from that configuration if the variance does not materially alter the capability of the invention.

What is claimed is:

1. A composite trellis having a base, comprising:
a crossbar comprising first and second halves, the first half comprising at least one projecting tab configured to mate with a corresponding slot in the second half; and
a plurality of rods positioned between the first and second halves such that, with the projecting tab mated into the slot the first and second halves are attached with the rods trapped therebetween.

2. The trellis of claim 1, wherein the projecting tab comprises at least one arrow-shaped protrusion and said slot comprises a channel forming a ledge, wherein, with the tab and slot mated, a lip of the protrusion engages the ledge such that the tab is secured within the slot.

3. The trellis of claim 2, wherein the projecting tab comprises first and second arrow-shaped protrusions and the slot comprises horizontal and vertical channels arranged in a “T”-shape defining first and second ledges positioned on opposite sides of the vertical channel, wherein, with the tab and slot mated, a lip of the first protrusion engages the first ledge and a lip of the second protrusion engages the second ledge such that the tab is secured within the slot.

4. The trellis of claim 1, wherein the first and second halves are further secured together with an adhesive.

5. The trellis of claim 4, wherein the plurality of rods are secured to at least one of the first and second halves with an adhesive.

6. The trellis of claim 1, wherein said lower crossbar is comprised of a fiber reinforced resin.

7. The trellis of claim 1, further comprising a second crossbar having a plurality of apertures formed therethrough, each of the apertures sized to receive a corresponding one of the plurality of rods such that the rods are positioned in a desired spaced-apart relationship.

8. The trellis of claim 1, wherein the first and second halves each comprise a plurality of aligned recessed areas sized and configured to conform to a corresponding rod such that, with the first and second halves attached, the aligned recessed areas encompass and trap the rod between the halves.

9. A composite trellis having a base, comprising:
a lower crossbar comprising first and second halves, the first half including a base with a plurality of tabs projecting outward from the base, the tabs configured to mate with respective corresponding slots in the second half, and wherein the first and second halves each comprise a plurality of aligned recessed areas sized and configured to conform to a corresponding rod; and
a plurality of rods positioned between the first and second halves such that, with the projecting tabs mated in the slots, the first and second halves are attached with the rods trapped therebetween in the corresponding aligned recessed areas in the two halves.

10. The trellis of claim 9, wherein each projecting tab comprises two arrow-shaped protrusions in opposite orientation, and wherein each slot comprises a vertical channel and a horizontal channel arranged in a “T” shaped configuration.

11. The trellis of claim 9, wherein the first and second halves are further secured together with an adhesive.

12. The trellis of claim 9, further comprising a second crossbar having a plurality of apertures formed therethrough, wherein each of the apertures is sized to receive a corresponding one of the plurality of rods such that the rods are positioned in a desired spaced-apart relationship.
